(19) United States
(12) Patent Application Publication
(10) Pub. No.: US 2023/0296449 A1
(43) Pub. Date: Sep. 21, 2023

(54) TEMPERATURE SENSOR

(71) Applicant: FURUKAWA ELECTRIC CO., LTD., Tokyo (JP)

(72) Inventor: Hideaki HASEGAWA, Tokyo (JP)

(73) Assignee: FURUKAWA ELECTRIC CO., LTD., Tokyo (JP)

(21) Appl. No.: 18/184,026

(22) Filed: Mar. 15, 2023

(30) Foreign Application Priority Data
Mar. 17, 2022 (JP) 2022-042252

(51) Int. Cl. G01K 11/32

(52) U.S. Cl. CPC G01K 11/32

(57) ABSTRACT

A temperature sensor includes: a light source outputting test light; a sensor optical fiber transmitting, when the test light is inputted, the test light at any temperature within a temperature range of 20° C. to 150° C. with a loss of 0.3 dB/m or more; a light receiver receiving the test light transmitted by the sensor optical fiber; and a processing device detecting temperature of the sensor optical fiber based on intensity of the test light received by the light receiver. The sensor optical fiber includes a core, and a clad provided on an outer circumference of the core; and, when the temperature of the sensor optical fiber increases, the temperature sensor 1 detects the temperature with a change in the intensity of the test light received by the light receiver increases, caused by an increase in a refractive index difference between the core and the clad, and an increase in confinement of the test light transmitted in the core.

This application is based on and claims the benefit of priority from Japanese Patent Application No. 2022-042252, filed on 17 Mar. 2022, the content of which is incorporated herein by reference.

### BACKGROUND OF THE INVENTION

### Field of the Invention

The present invention relates to a temperature sensor.

### Related Art

An apparatus for detecting temperature using an optical fiber has been conventionally known. As an example in which this kind of technology is disclosed, Japanese Unexamined Patent Application, Publication No. 2018-68673 is given. In Japanese Unexamined Patent Application, Publication No. 2018-68673, an apparatus is described which includes: an optical fiber device causing first reflected light and second reflected light to occur by laser light being incident to the optical fiber device, a light receiver receiving interference light of the first and second reflected light emitted from the optical fiber device, and an analyzer analyzing a signal outputted from the light receiver.

Patent Document 1: Japanese Unexamined Patent Application, Publication No.2018-68673

### SUMMARY OF THE INVENTION

In the apparatus of Japanese Unexamined Patent Application, Publication No. 2018-68673, however, temperature is measured by detecting the output signal of the light receiver while changing the wavelength of the irradiated laser light to detect a wavelength shift amount, and an expensive large-size device, such as an optical spectrum analyzer, is required to detect the wavelength.

The present invention has been made in view of the above situation, and an object is to provide an inexpensive small-size temperature sensor.

The present invention relates to a temperature sensor, the temperature sensor including: a light source outputting test light, a sensor optical fiber transmitting, when the test light is inputted, the test light at any temperature within a temperature range of 20° C. to 150° C. with a loss of 0.3 dB/m or more, and a light receiver receiving the test light transmitted by the sensor optical fiber; and the temperature sensor detecting temperature of the sensor optical fiber based on intensity of the test light received by the light receiver.

The sensor optical fiber may include a core, and a clad provided on an outer circumference of the core; and, when the temperature of the sensor optical fiber increases, the intensity of the test light received by the light receiver may increase, by a refractive index difference between the core and the clad increasing, and confinement of the test light transmitted in the core becoming stronger.

The sensor optical fiber may include the core, and the clad provided on the outer circumference of the core; and a diameter of the core may be equal to or more than ten times a thickness of the clad.

The sensor optical fiber may include the core, and the clad provided on the outer circumference of the core; and a plurality of nanostructures exist near an interface between the core and the clad; and a cross-sectional diameter of a cross section of each of the nanostructures may be 100 nm or less, the cross section being perpendicular to a longitudinal direction of the sensor optical fiber, and the nanostructures may be distributed in areas in the longitudinal direction, each of the areas having a length below 1 m.

According to the present invention, it is possible to provide an inexpensive small-size temperature sensor.

### BRIEF DESCRIPTION OF THE DRAWINGS

FIG. 1 is a schematic diagram showing a temperature sensor according to one embodiment of the present invention;

FIG. 2 is a schematic diagram showing a structure of a sensor optical fiber of the temperature sensor according to the one embodiment of the present invention;

FIG. 3 is a schematic diagram showing change in refractive indexes of the core and clad of the temperature sensor according to the one embodiment of the present invention and in light distribution accompanying increase in temperature;

FIG. 4 is a schematic diagram showing a relationship between transmission loss of the sensor optical fiber according to the one embodiment of the present invention and light distribution;

FIG. 5 is a schematic diagram showing a test method for a light output evaluation test;

FIG. 6 is a diagram showing a relationship between temperature of the temperature sensor and optical output increase rate; and

FIG. 7 is a schematic diagram showing change in a refractive index of a core of a modification example of the sensor optical fiber of the temperature sensor according to the one embodiment of the present invention and in light distribution accompanying increase in temperature.

### DETAILED DESCRIPTION OF THE INVENTION

### Embodiment

A temperature sensor 1 according to an embodiment of the present invention will be described below. The present invention is not limited to the embodiment below. Drawings referred to in the description below only schematically show shapes, sizes, and positional relationships so that the content of the present disclosure can be understood. That is, the present invention is not limited only to the shapes, sizes, and positional relationships exemplified in the drawings.

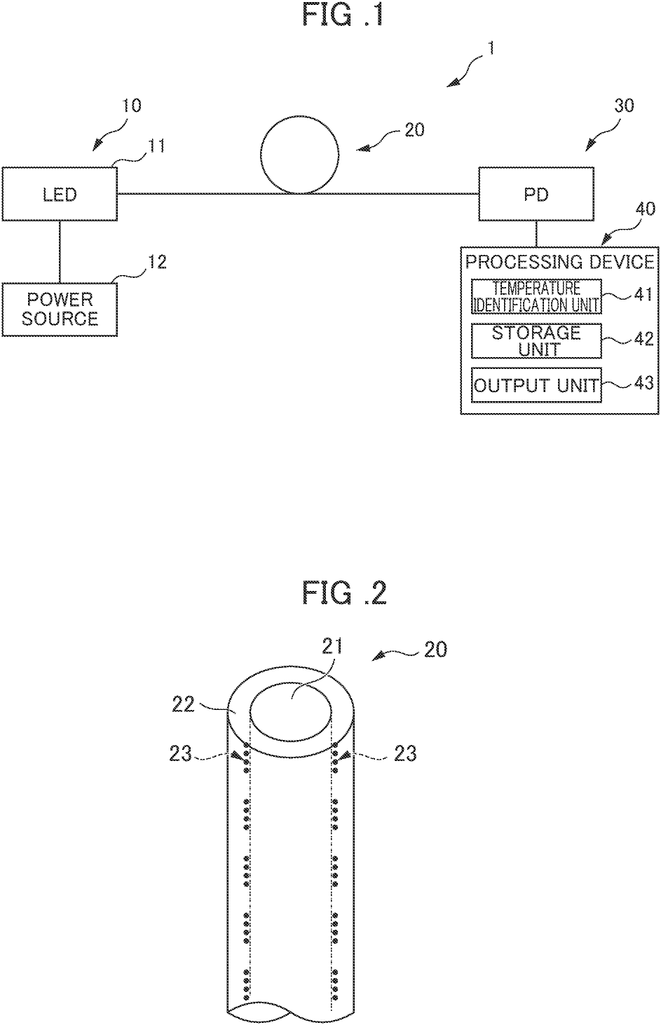

First, a configuration of the temperature sensor 1 according to the present embodiment will be described with reference to FIG. 1. FIG. 1 is a schematic diagram showing the temperature sensor 1.

The temperature sensor 1 includes a light source 10, a sensor optical fiber 20, a PD (photo diode) 30 which is a light receiver, and a processing device 40 which is a detector.

The light source 10 has an LED 11, and a power source 12 that supplies power to the LED 11. The LED 11 outputs test light to the sensor optical fiber 20 using power supplied from the power source 12. The wavelength of the test light outputted from the LED 11 is not especially limited. In the present embodiment, blue light with a wavelength of 470 nm is outputted from the LED 11 to the sensor optical fiber 20.

One end of the sensor optical fiber 20 is optically connected to the LED 11, and the other end is optically connected to the PD 30. The sensor optical fiber 20 transmits the test light inputted from the LED 11, to the PD 30 with a loss of 0.3 dB/m or more at any temperature within a temperature range of 20° C. to 150° C. By causing the transmission loss of the sensor optical fiber 20 to be 0.3 dB/m or more at any temperature within the temperature range of 20° C. to 150° C., it becomes possible to detect temperature based on intensity of the test light. The principle of detection of temperature by the temperature sensor 1 will be described later.

A configuration of the sensor optical fiber 20 will be described with reference to FIG. 2. FIG. 2 is a schematic diagram of the sensor optical fiber 20 used in the temperature sensor 1.

The sensor optical fiber 20 according to the present embodiment is made of quartz-based material and has a core 21, and a clad 22 provided around the outer circumference of the core 21.

It is favorable that the diameter of the core 21 is equal to or more than ten times the thickness of the clad 22. Thereby, it becomes easy for heat from outside to be transferred to the core 21. The refractive index of the core 21 is higher than the refractive index of the clad 22. The central part of the core 21 of the sensor optical fiber 20 of the present embodiment is doped with germanium.

The sensor optical fiber 20 of the present embodiment is configured so that, when the temperature thereof increases, a refractive index difference between the core 21 and the clad 22 increases.

In the sensor optical fiber 20, a plurality of nanostructures 23 exist near the interface between the core 21 and the clad 22. The nanostructures 23 may exist over the whole or a part of the clad 22 in the radial direction of the clad 22. Each nanostructure 23 is, for example, a nanoscale fine particle, a cylindrical tube, or a void, and at least two kinds among the fine particle, cylindrical tube, and void may be included.

The PD 30 receives the test light transmitted by the sensor optical fiber 20, converts the test light to a current signal corresponding to intensity of the test light, and outputs the current signal to the processing device 40.

The processing device 40 includes a temperature identification unit 41, a storage unit 42, and an output unit 43. The temperature identification unit 41 is configured with a processor and corresponds to the central part of a computer that performs processing for operation, control, and the like required for operation of the processing device 40. The processor is, for example, a CPU (central processing unit), an MPU (micro processing unit), SoC (system-on-a-chip), a DSP (digital signal processor), a GPU (graphics processing unit), an ASIC (application specific integrated circuit), a PLD (programmable logic device), an FPGA (field-programmable gate array), or the like. Or alternatively, the processor may be a combination of two or more of the above.

The temperature identification unit 41 acquires the intensity of the test light based on the current signal inputted from the PD 30. Then, the temperature identification unit 41 detects temperature of the sensor optical fiber 20 based on the acquired intensity of the test light. For example, the temperature identification unit 41 may refer to information showing a relationship between intensity of test light received by the PD 30 and temperature, which is specified for each sensor optical fiber 20 in advance, to identify the temperature from the acquired intensity of the test light. By detecting the temperature of the sensor optical fiber 20, the temperature of an object to be measured (gas, liquid, a solid, or the like) that is in contact with the outer surface of the sensor optical fiber 20 can be identified. Specifically, the temperature identification unit 41 detects an average temperature of an area where the sensor optical fiber 20 is in contact with the object to be measured. Then, the temperature identification unit 41 measures a difference between a temperature in the case of the object to be measured not being in contact with the sensor optical fiber 20 and a temperature in the case of the object to be measured being in contact with the sensor optical fiber 20, and calculates the difference as the temperature of the object to be measured.

The storage unit 42 is a storage area for various kinds of programs for the temperature identification unit 41 to perform processing for operation, control, and the like, various kinds of data, and the like, and can be configured with a ROM, a RAM, a flash memory, a semiconductor drive (SSD), or a hard disk (HDD) The storage unit 42 stores, for example, information about the current signal inputted from the PD 30, information about time when the current signal was inputted, information about the intensity of the test light calculated from the current signal, the information showing a relationship between the intensity of the test light received by the PD 30 and temperature, information about temperature calculated by the temperature identification unit 41, and the like.

The output unit 43 is configured with a display, a speaker, and the like, and outputs an image and sound. The output unit 43 may be configured to display, for example, the temperature of the sensor optical fiber 20 calculated by the temperature identification unit 41 on the display.

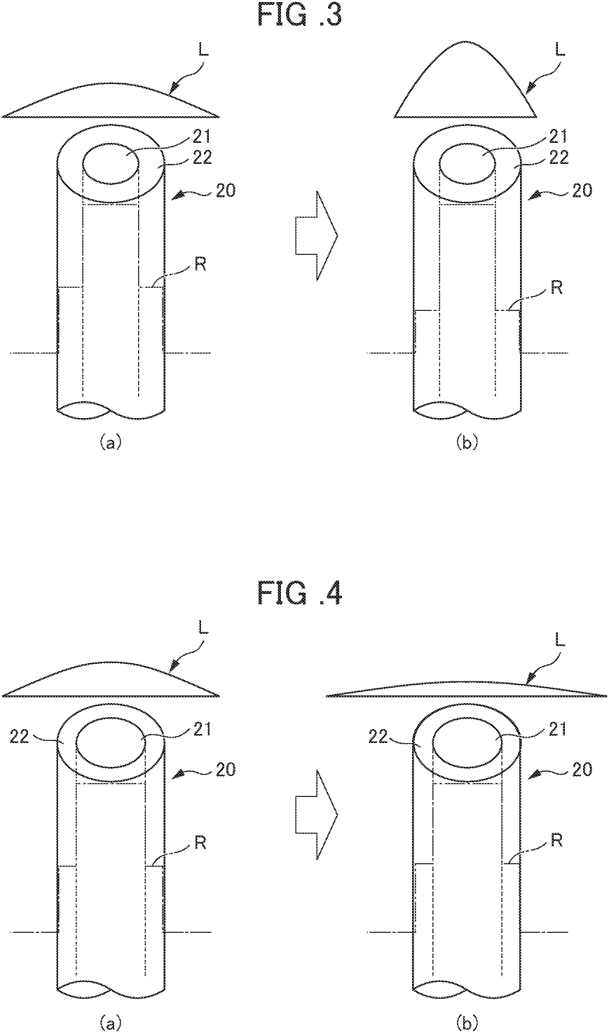

Next, description will be made on the principle of detection of temperature by the temperature sensor 1 that is provided with the sensor optical fiber 20 with a transmission loss of 0.3 dB/m or more, with reference to FIG. 3. FIG. 3 is a schematic diagram showing change in the refractive indexes of the core 21 and the clad 22 of the sensor optical fiber 20 and in distribution of the test light accompanying increase in temperature.

(a) of FIG. 3 shows the sensor optical fiber 20 in a low-temperature state, and (b) of FIG. 3 shows the sensor optical fiber 20 in a high-temperature state. In FIG. 3, a long dashed short dashed line R indicates magnitudes of the refractive index of the outside of the sensor optical fiber 20 (an air layer covering the sensor optical fiber 20), the refractive index of the clad 22, and the refractive index of the core 21. In FIG. 3, it is meant that, the higher the position is, the larger the refractive indexes are.

In the example shown in FIG. 3, when temperature of the sensor optical fiber 20 increases, the refractive index difference between the core 21 and the clad 22 increases, and the light confining effect of the core 21 becomes stronger. Thereby, as shown in (b) of FIG. 3, test light L distributed even up to the outer layer of the sensor optical fiber 20 is confined in the core 21, and diffusion of the test light L to the outside is restrained. That is, when the temperature of the sensor optical fiber 20 increases, intensity of the test light L received by the PD 30 increases. The temperature sensor 1 detects the temperature of the sensor optical fiber 20 utilizing the relationship between temperature and the intensity of the test light L.

Next, description will be made on influence on the detection sensitivity of the temperature sensor 1 by transmission loss of the sensor optical fiber 20 with reference to FIG. 4.

FIG. 4 is a schematic diagram showing the refractive indexes of the core 21 and the clad 22 of sensor optical fibers 20 with different light transmission losses, and distribution of the test light L. (a) of FIG. 4 shows a sensor optical fiber 20 with a small light transmission loss, and (b) of FIG. 4 shows a sensor optical fiber 20 with a large light transmission loss. In FIG. 4, a long dashed short dashed line R indicates magnitudes of the refractive index of the outside (in the air) of the sensor optical fiber 20, the refractive index of the clad 22, and the refractive index of the core 21. In FIG. 4, it is meant that, the higher the position is, the larger the refractive index indicated by the long dashed short dashed line R is.

The sensor optical fibers 20 shown in (a) and (b) of FIG. 4 are the same in the refractive indexes of the core 21 and the clad 22 and in the temperature but are different only in the light transmission loss. The degree of the test light L leaking to the outside is higher in the sensor optical fiber 20 shown in (b) of FIG. 4 with a larger transmission loss, than in the sensor optical fiber 20 shown in (a) of FIG. 4. That is, it can be confirmed that the degree of test light leaking to the outside is higher in the sensor optical fiber 20 with a larger transmission loss even if the refractive index differences between the core 21 and the clad 22 are the same.

Here, description will be made on an amount of change in light output of the sensor optical fiber 20 (intensity of test light received by the PD 30) due to temperature. The amount of change in light output due to temperature is shown by Formula (1) below.

Amount of change in light output due to temperature=transmission loss due to structure near interface between core 21 and clad 22×change in power of test light localized on interface between core 21 and clad 22 due to temperature ⋯ (1)

For example, by providing a scattering structure near the interface between the core 21 and the clad 22, the transmission loss of the sensor optical fiber 20 can be increased. In the sensor optical fiber 20 the light transmission loss of which has been increased by the above scattering structure or the like, the degree of leak of test light at a low temperature is still higher, and, therefore, change in light intensity distribution due to the effect of confinement in the core 21 at the time of increase in temperature also increases. Therefore, it is seen that there is a combined effect on change in transmission loss due to temperature.

As shown by Formula (1), the detection sensitivity of the temperature sensor 1 is higher as the amount of change in light output due to temperature is larger. On the other hand, in a case where the transmission loss is small, and light output is high even at a low temperature, the amount of change in light output due to increase in temperature is small, and it is thought that detection sensitivity that is high enough for the temperature sensor 1 to function cannot be obtained. As shown by results of light output evaluation tests described later, it becomes possible to, by setting the transmission loss of the sensor optical fiber 20 to 0.13 dB/m or more, detect temperature.

Next, description will be made on a configuration near the interference between the core 21 and the clad 22 that influences transmission loss of the sensor optical fiber 20 with reference to FIG. 2.

In the nanostructures 23, such as voids or metal particles, existing near the interface between the core 21 and the clad 22, the cross-sectional diameter of a cross section perpendicular to the longitudinal direction of the sensor optical fiber 20 is 100 nm or less. If the cross-sectional diameter of each nanostructure 23 is 100 nm or more, the area occupied by air in the case of voids or by metal in the case of metal particles in the cross section increases, and an effective refractive index difference from the core 21 made of quartz-based material increases. Therefore, light leak or light diffusion becomes difficult to occur. Therefore, by setting the cross-sectional diameter to 100 nm or less, the sensitivity to temperature can be higher, and excessive loss can be restrained. It is desired that the cross-sectional diameter is larger than the molecular size of quartz and is equal to or more than the lowest limit of 1 nm that influences light.

Further, as shown in FIG. 2, the plurality of nanostructures 23 are distributed in areas in the longitudinal direction of the sensor optical fiber 20, each of the areas having a length below 1 m. Here, being distributed in areas, each of which has a length below 1 m, means that the length of each area in which nanostructures 23 continuously exist is below 1 m. For example, in FIG. 2, there are a plurality of areas, in each of which nanostructures 23 continuously exist, and any of the areas has a length below 1 m in the longitudinal direction. Thereby, it is possible to restrain excess loss due to the nanostructures 23 and influence given to propagation characteristics.

The sensor optical fiber 20 having the plurality of nanostructures 23 can be manufactured, for example, by applying an optical fiber manufacturing method disclosed in National Publication of International Patent Application No. 2013-511749. In a case where the nanostructures 23 are not voids but fine particles, the sensor optical fiber 20 can be manufactured, for example, by causing the fine particles to be mixed into a gap between a core base material and a glass capillary as the clad 22 and then wire-drawing the optical fiber base material. If the fine particles are made of material with a melting point of 1500° C. or higher, melting and transformation of the fine particles can be prevented even under a high temperature of about 1400° C., which is heating temperature at the time of wire-drawing of a quartz-based optical fiber base material. As such material that the melting point is high, carbon, tantalum, molybdenum, chromium oxide, zirconium oxide, or the like can be appropriately selected.

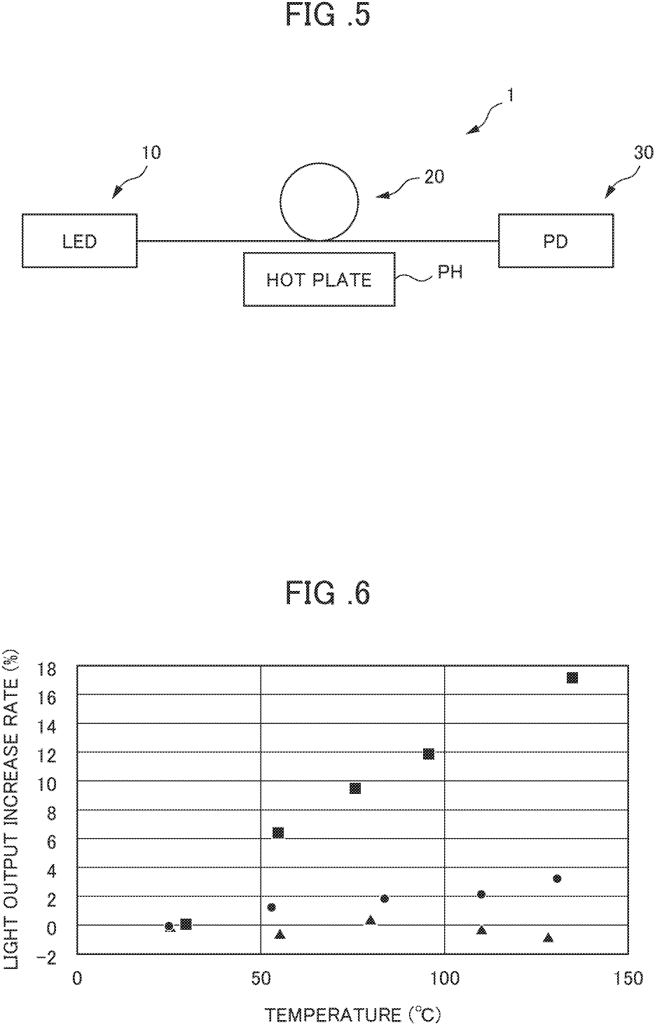

Next, description will be made on light output evaluation tests in which a relationship between transmission loss of the sensor optical fiber 20, temperature, and light output was confirmed, with reference to FIGS. 5 and 6. FIG. 5 is a schematic diagram showing a method for the light output evaluation tests. In FIG. 5, the power source 12 and the processing device 40 of the temperature sensor 1 are not shown.

As shown in FIG. 5, in the light output evaluation tests, each of sensor optical fibers with the light source 10 connected with one end, with the PD 30 connected with the other end, and with about 50 cm of its coating removed in the longitudinal direction is placed on a hot plate PH, and intensity of test light outputted from the sensor optical fiber to the PD 30 in the case of changing temperature from about 30° C. to about 130° C. is measured. As the sensor optical fibers, those with transmission losses of 0.02 dB/m, 0.3 dB/m, and 3.0 dB/m were used. Each of the tree sensor optical fibers has a core diameter of 43 µm, a clad thickness of 63.5 µm, and an overall outer diameter of 170 µm.

FIG. 6 is a graph showing a relationship between temperature and light output increase rate for the sensor optical fibers with the different transmission losses. The horizontal axis in FIG. 6 indicates temperature (°C) of the hot plate, and the vertical axis in FIG. 6 indicates the light output increase rate (%) according to temperature when light output at a room temperature of 25° C. is used as a reference. In FIG. 6, triangle plots indicate evaluation results for the sensor optical fiber with the transmission loss of 0.02 dB/m; circle plots indicate evaluation results for the sensor optical fiber with the transmission loss of 0.3 dB/m; and square plots indicate evaluation results for the sensor optical fiber with the transmission loss of 3.0 dB/m.

In the general sensor optical fiber with the transmission loss of 0.02 dB/m, the light output increase rates at temperatures from about 30° C. to about 130° C. are about 0%. That is, it can be confirmed that the light output of the sensor optical fiber is almost constant regardless of temperature. In comparison, in the sensor optical fiber with the transmission loss of 0.3 dB/m, the light output increase rate increases accompanying increase in temperature. From this result, it can be confirmed that, in the sensor optical fiber with the transmission loss of 0.3 dB/m or more, light output monotonously increases according to temperature.

In the sensor optical fiber with the transmission loss of 3.0 dB/m, change in light output accompanying increase in temperature is further greater. For example, when intensity of output light is 1 mW, the intensity changes by 80 µW due to increase in temperature from 30° C. to 60° C., and a rate of change in intensity of output light (hereinafter referred to as the light output change rate) according to temperature is 2.67 µW/°C. For example, if a PD 30 with a detection accuracy of 0.01 µW is used, change in temperature by about 0.01° C. is to be detected. From this result, it can be confirmed that, by increasing the transmission loss of the sensor optical fiber 20, the temperature detection sensitivity is improved. The sensor optical fiber 20 according to the present embodiment is configured to transmit the test light L with a light output change rate of 0.008 µW/°C or higher, within the temperature range of 20° C. to 150° C. The temperature sensor 1 according to the present embodiment can accurately detect temperature within the range of 20° C. to 150° C.

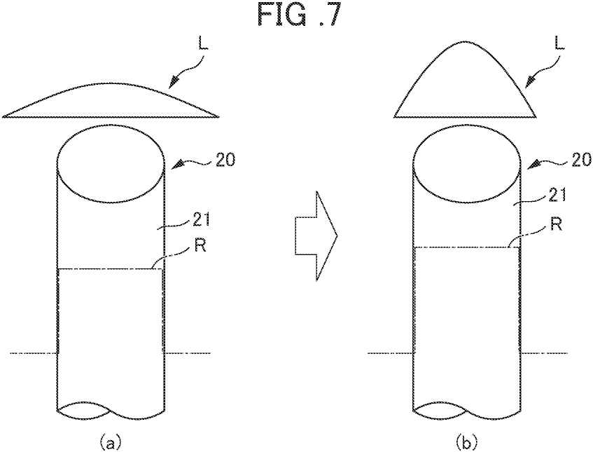

In the above embodiment, such a modification of the sensor optical fiber configuration as below can be adopted. A configuration of a sensor optical fiber 20A will be described with reference to FIG. 7 while the above description being quoted.

FIG. 7 is a schematic diagram showing change in the refractive index of a core 21A of the sensor optical fiber 20A and in light distribution of the test light L accompanying increase in temperature. (a) of FIG. 7 shows the sensor optical fiber 20A in a low-temperature state, and (b) of FIG. 7 shows the sensor optical fiber 20A in a high-temperature state. In FIG. 7, a long dashed short dashed line R indicates magnitudes of the refractive index of the outside (in the air) of the sensor optical fiber 20A and the refractive index of the core 21A. In FIG. 7, it is meant that, the higher the position is, the larger the refractive index indicated by the long dashed short dashed line R is.

As shown in FIG. 7, the sensor optical fiber 20A is different from the sensor optical fiber 20 mainly in not having the clad 22 or the nanostructures 23. The sensor optical fiber 20A is made of quartz-based material such as a quartz rod, and has the core 21A. As shown in FIG. 7, the sensor optical fiber 20A is an air-clad fiber that transmits the test light L by a refractive index difference between the core 21A and an air layer around the core 21A. Side faces of the quartz rod of the core 21A of the sensor optical fiber 20A are roughened so that the transmission loss is set high.

In the example shown in FIG. 7, when temperature of the sensor optical fiber 20A increases, the refractive index of the core 21 increases, and the refractive index difference between the core 21 and the air layer increases. Thus, the light confining effect of the core 21 becomes stronger. Thereby, as shown in (b) of FIG. 7, the test light L distributed even up to the outer layer of the sensor optical fiber 20A is confined in the core 21A, and leak of the test light L is restrained. That is, when the temperature of the sensor optical fiber 20A increases, intensity of the test light L received by the PD 30 increases.

According to the embodiment described above, the following effects are obtained.

A temperature sensor 1 according to the present embodiment includes: a light source 10 outputting test light; a sensor optical fiber 20 transmitting, when the test light is inputted, the test light at any temperature within a temperature range of 20° C. to 150° C. with a loss of 0.3 dB/m or more; a PD 30 receiving the test light transmitted by the sensor optical fiber 20; and a processing device 40 detecting temperature of the sensor optical fiber 20 based on intensity of the test light received by the PD 30.

Thereby, since the transmission loss of the sensor optical fiber 20 is 0.3 dB/M or more, the light output of the sensor optical fiber 20 changes according to temperature, and the temperatures of the sensor optical fiber 20 and an object that is in contact with the sensor optical fiber 20 can be detected from the intensity of the received test light. In comparison with an optical fiber temperature sensor that measures temperature from wavelength shift, the necessity of a light spectrum analyzer or the like is eliminated, and temperature can be detected with an inexpensive small-size configuration. Further, since the temperature sensor 1 has a simple structure and a small diameter, it can be used even under a harsh environment. Therefore, the temperature sensor 1 is promising for detection of temperature, for example, in a gas tank, piping, and an oil well.

In the temperature sensor 1 according to the present embodiment, the sensor optical fiber 20 includes a core 21, and a clad 22 provided on an outer circumference of the core 21; and, when the temperature of the sensor optical fiber 20 increases, the intensity of the test light received by the PD 30 increases, caused by a substantial increase in a refractive index difference between the core 21 and the clad 22 around the nanostructures, and an increase in confinement of the test light transmitted in the core 21 around the nanostructures. The temperature sensor 1 detects the temperature with a change in the intensity of the test light L.

Thereby, it is possible to accurately detect the temperatures of the sensor optical fiber 20 and an object that is in contact with the sensor optical fiber 20 based on the intensity of the received test light.

In the temperature sensor 1 according to the present embodiment, the sensor optical fiber 20 includes the core 21 and the clad 22 provided on the outer circumference of the core 21; and a diameter of the core 21 is equal to or more than ten times a thickness of the clad 22.

Thereby, since the thickness of the clad 22 relative to the core 21 is thin, an amount of the test light that leaks from the outer layer of the sensor optical fiber 20 at a low temperature or the like can be increased. Further, since it becomes easy for heat from the outside to be transferred to an interface between the core 21 and the clad 22, the sensitivity of detection of outside temperature can be improved.

In the temperature sensor 1 according to the present embodiment, the sensor optical fiber 20 includes the core 21 and the clad 22 provided on the outer circumference of the core 21; and a plurality of nanostructures 23 exist near the interface between the core 21 and the clad 22; and a cross-sectional diameter of a cross section of each of the nanostructures 23 is 100 nm or less, the cross section being perpendicular to a longitudinal direction of the sensor optical fiber 20, and the nanostructures 23 are distributed in areas in the longitudinal direction, each of the areas having a length below 1 m.

Thereby, since the transmission loss of the sensor optical fiber 20 can be improved, the sensitivity of the temperature sensor 1 can be improved.

An embodiment of the present invention has been described above. The present invention, however, is not limited to the above embodiment and can be appropriately changed.

Though the temperature sensor 1 includes the sensor optical fiber 20 or 20A in the above embodiment, a configuration is also possible in which a plastic fiber that diffuses light by the unevenness on the sides of the optical fiber is provided instead of the sensor optical fiber 20 or 20A.

Though the diameter of the core 21 of the sensor optical fiber 20 is equal to or more than ten times the thickness of the clad 22 in the above embodiment, the diameter may be less than ten times. Further, a configuration is also possible in which the thickness of the clad 22 is thicker than the diameter of the core 21.

Though the above embodiment adopts the configuration in which the plurality of nanostructures 23 exist near the interface between the core 21 and the clad 22, a configuration is also possible in which the plurality of nanostructures 23 do not exist.

Though the above embodiments adopt the configuration in which, when the temperature of the sensor optical fiber 20 increases, the refractive index difference between the core 21 and the clad 22 around the nanostructures increases, a configuration is also possible in which the refractive index difference between the core 21 and the clad 22 decreases due to increase in temperature. By changing the glass composition of a sensor optical fiber or additives to a core, a sensor optical fiber 20 configured so that a refractive index difference between a core and a clad decreases due to increase in temperature can be fabricated.

EXPLANATION OF REFERENCE NUMERALS

| | |
|---|---|
| 1 | Temperature sensor |
| 10 | Light source |
| 20 | Sensor optical fiber |
| 30 | PD (light receiver) |
| 40 | Processing device (detection unit) |

What is claimed is:

1. A temperature sensor comprising:
a light source outputting test light;
a sensor optical fiber transmitting, when the test light is inputted, the test light at any temperature within a temperature range of 20° C. to 150° C. with a loss of 0.3 dB/m or more;
a light receiver receiving the test light transmitted by the sensor optical fiber; and
a detection unit detecting temperature of the sensor optical fiber based on intensity of the test light received by the light receiver; wherein
the sensor optical fiber comprises a core, and a clad provided on an outer circumference of the core; and
when the temperature of the sensor optical fiber increases, the detection unit detects the temperature with a change in the intensity of the test light received by the light receiver, caused by an increase in a refractive index difference between the core and the clad, and an increase in confinement of the test light transmitted in the core.

2. The temperature sensor according to claim 1, wherein, in the sensor optical fiber, a diameter of the core is equal to or more than ten times a thickness of the clad.

3. The temperature sensor according to claim 2, wherein
in the sensor optical fiber, a plurality of nanostructures exist near an interface between the core and the clad; and
a cross-sectional diameter of a cross section of each of the nanostructures is 100 nm or less, the cross section being perpendicular to a longitudinal direction of the sensor optical fiber, and the nanostructures are distributed in areas in the longitudinal direction, each of the areas having a length below 1 m.

4. The temperature sensor according to claim 3, wherein the sensor optical fiber transmits the test light with a light output change rate of 0.008 µW/°C or higher within the temperature range of 20° C. to 150° C.
